(19) United States
(12) Patent Application Publication
(10) Pub. No.: US 2025/0375789 A1
(43) Pub. Date: Dec. 11, 2025

(54) COATING SHIM FOR ELECTRODE SLURRY DISCHARGE, ELECTRODE SLURRY COATING DIE AND ELECTRODE MANUFACTURING DEVICE

(71) Applicant: SK On Co., Ltd., Seoul (KR)

(72) Inventors: Chang Geun SON, Daejeon (KR); Kyung Wan KANG, Daejeon (KR); Yong Bok MOON, Daejeon (KR)

(21) Appl. No.: 19/224,899

(22) Filed: Jun. 2, 2025

(30) Foreign Application Priority Data
Jun. 5, 2024 (KR) 10-2024-0073814

(51) Int. Cl. B05C 5/02; H01M 4/04

(52) U.S. Cl. CPC B05C 5/0254; H01M 4/0411

(57) ABSTRACT

A coating shim for electrode slurry discharge includes a hollow region through which an electrode slurry may flow and a frame surrounding at least a part of the hollow region. The frame includes a base portion extending in one direction to form one side surface of the hollow region; side portions extending at opposite ends of the base portion in a direction different from the one direction; and guide portions extending at respective ends of the side portions to face each other and to be spaced apart from each other to form a discharge port therebetween which allows the hollow region to communicate with outside. The guide portions have inclined surfaces at respective ends thereof such that a distance between lower portions of the guide portions is greater than a distance between upper portions of the guide portions.

### CROSS-REFERENCE TO RELATED PATENT APPLICATION

The present disclosure claims priority under 35 U.S.C. § 119 (a) to Korean patent application number 10-2024-0073814, filed on Jun. 5, 2024, in the Korean Intellectual Property Office, the entire disclosure of which is incorporated herein by reference.

### BACKGROUND OF THE INVENTION

### 1. Field

Various embodiments of the present disclosure generally relate to a coating shim for electrode slurry discharge, an electrode slurry coating die, and an electrode manufacturing device. More specifically, a coating shim for electrode slurry discharge, an electrode slurry coating die, and an electrode manufacturing device capable of improving the processability by enhancing the coating quality.

### 2. Description of the Related Art

An electrode of a secondary battery is manufactured by applying an electrode slurry containing a mixture of an active material and a conductive material onto metal foil, drying the metal foil with the electrode slurry applied thereto at a high temperature, and then pressing the same. A coating die for electrode production is equipment for applying the electrode slurry onto the metal foil.

A slot die refers to equipment which supplies liquid fluid having fluidity (a slurry, an adhesive agent, a hard coating agent, ceramic, or the like) between upper and lower slot dies by a non-pulsatile pump or a piston pump, and coats an object to be coated, such as a fabric, a film, a glass plate, and a sheet, with the fluid supplied from a liquid supply pipe to a certain thickness in a width direction in the running direction of the object to be coated. An electrode slurry coating die is the application of the slot die for electrode production, and is equipment which applies the electrode slurry, which is the supplied fluid, on the metal foil to manufacture the electrode of the secondary battery.

When applying the electrode slurry, an electrode side ring phenomenon may occur due to physical properties of the slurry, or the like, and defects such as a rapid decrease in the thickness of the electrode at the edge or extraction of the electrode may occur. These defects can lead to problems in a post-coating process where production yields and facility utilization rates fall.

Therefore, there is a need for a new coating device capable of improving the processability by enhancing the coating quality.

### SUMMARY OF THE INVENTION

Various embodiments of the present disclosure provide a coating shim for electrode slurry discharge, an electrode slurry coating die, and an electrode manufacturing device capable of improving the processability by enhancing the coating quality.

Various embodiments of the present disclosure can be widely applied in the green technology fields such as electric vehicles, battery charging stations, energy storage systems (ESSs), and other technologies using batteries such as photovoltaics and wind power. In addition, various embodiments of the present disclosure can also be used for eco-friendly mobility, including electric and hybrid vehicles, to reduce air pollution and greenhouse gas emissions to prevent or reduce climate change.

A coating shim for electrode slurry discharge according to embodiments of the present disclosure includes a hollow region through which an electrode slurry may flow and a frame surrounding at least a part of the hollow region. The frame includes a base portion extending in one direction to form one side surface of the hollow region; side portions extending at opposite ends of the base portion in a direction different from the one direction; and guide portions extending at respective ends of the side portions to face each other and to be spaced apart from each other to form a discharge port therebetween which allows the hollow region to communicate with outside. The guide portions have inclined surfaces at respective ends thereof such that a distance between lower portions of the guide portions is greater than a distance between upper portions of the guide portions.

In an embodiment, the side portions may extend in a same direction at the opposite ends of the base portion, and an upper end and a lower end of each of the inclined surfaces may be parallel to the direction in which the side portions extend.

In an embodiment, the inclined surfaces may be formed such that a difference between the distance between the lower portions of the guide portions and the distance between the upper portions of the guide portions is greater than or equal to 0.5 mm and less than or equal to 5.0 mm.

In an embodiment, each of the inclined surfaces may be a flat surface.

In an embodiment, a slope of each of the inclined surfaces may be greater than or equal to 0.10 and less than or equal to 6.00.

In an embodiment, each of the inclined surfaces may be a curved surface.

In an embodiment, a slope of each of the inclined surfaces may increase from an upper end toward a lower end thereof.

In an embodiment, a radius of curvature of each of the inclined surfaces may be greater than or equal to 0.5 mm and less than or equal to 3.0 mm.

In an embodiment, each of the inclined surfaces may include first to n-th sub-surfaces (n is a natural number of 2 or more). In terms of the first to n-th sub-surfaces, the n-th sub-surface may be positioned to be in contact with a lower end of the (n−1)-th sub-surface with different slopes from each other. Each of the first to n-th sub-surfaces may be a flat surface.

An electrode slurry coating die according to embodiments of the present disclosure includes a die portion including an upper die and a lower die coupled to the upper die to form an inner space in which an electrode slurry is accommodated; a hollow region interposed between the upper die and the lower die and communicating with the inner space; and a frame surrounding at least a part of the hollow region. The frame includes a base portion extending in one direction to form one side surface of the hollow region; side portions extending at opposite ends of the base portion in a direction different from the one direction; and guide portions extending at respective ends of the side portions to face each other and to be spaced apart from each other to form a discharge port therebetween which allows the hollow region to communicate with outside. The guide portions have inclined surfaces at respective ends thereof such that a distance between lower portions of the guide portions is greater than a distance between upper portions of the guide portions.

In an embodiment, the side portions may extend in a same direction at the opposite ends of the base portion, and an upper end and a lower end of each of the inclined surfaces may be parallel to the direction in which the side portions extend.

In an embodiment, the inclined surfaces may be formed such that a difference between the distance between the lower portions of the guide portions and the distance between the upper portions of the guide portions is greater than or equal to 0.5 mm and less than or equal to 5.0 mm. In an embodiment, each of the inclined surfaces may be a flat surface or a curved surface.

An electrode manufacturing device according to embodiments of the present disclosure includes a transfer portion supporting and transferring an electrode current collector, and an electrode slurry coating die discharging an electrode slurry to the electrode current collector. The electrode slurry coating die includes a die portion including an upper die and a lower die coupled to the upper die to form an inner space in which the electrode slurry is accommodated; a hollow region interposed between the upper die and the lower die and communicating with the inner space; and a frame surrounding at least a part of the hollow region. The frame includes a base portion extending in one direction to form one side surface of the hollow region; side portions extending at opposite ends of the base portion in a direction different from the one direction; and guide portions extending at respective ends of the side portions to face each other and to be spaced apart from each other to form a discharge port therebetween which allows the hollow region to communicate with outside. The guide portions have inclined surfaces at respective ends thereof such that a distance between lower portions of the guide portions is greater than a distance between upper portions of the guide portions.

In an embodiment, a direction from a lower portion toward an upper portion of each of the guide portions may be the same as a direction in which the transfer portion transfers the electrode current collector.

According to various embodiments of the present disclosure, a coating shim for electrode slurry discharge, an electrode slurry coating die, and an electrode manufacturing device capable of improving the processability by enhancing the coating quality may be provided.

Various embodiments of the present disclosure can be widely applied in the green technology fields such as electric vehicles, battery charging stations, energy storage systems (ESSs), and other technologies using batteries such as photovoltaics and wind power. In addition, various embodiments of the present disclosure can also be used for eco-friendly mobility, including electric and hybrid vehicles, to reduce air pollution and greenhouse gas emissions to prevent or mitigate climate change.

### BRIEF DESCRIPTION OF THE DRAWINGS

FIG. 1 is a diagram illustrating a coating shim for electrode slurry discharge according to an embodiment of the present disclosure.

FIG. 2 is a cross-sectional view of a coating shim for electrode slurry discharge according to an embodiment of the present disclosure viewed from direction A of FIG. 1.

FIG. 3 is a cross-sectional view of a coating shim for electrode slurry discharge according to another embodiment of the present disclosure viewed from the same direction as in FIG. 2.

FIG. 4 is a cross-sectional view of a coating shim for electrode slurry discharge according to another embodiment of the present disclosure viewed from the same direction as in FIG. 2.

FIG. 5 is a cross-sectional view of a coating shim for electrode slurry discharge according to a comparative example viewed from the same direction as in FIG. 2.

FIG. 6 is a diagram illustrating an electrode slurry coating die according to an embodiment of the present disclosure.

FIG. 7 is a diagram illustrating an electrode manufacturing device according to an embodiment of the present disclosure.

FIG. 8 is a diagram illustrating an electrode manufactured by an electrode manufacturing device according to an embodiment of the present disclosure.

FIG. 9 is a diagram illustrating an electrode manufactured by an electrode manufacturing device according to a comparative example.

### DETAILED DESCRIPTION

Specific structural or functional descriptions disclosed herein are merely illustrative for the purpose of describing embodiments according to the technical spirit of the present disclosure. Embodiments according to the technical spirit of the present disclosure may be implemented in various forms in addition to the embodiments disclosed herein, and should not be construed as being limited to the specific embodiments set forth herein.

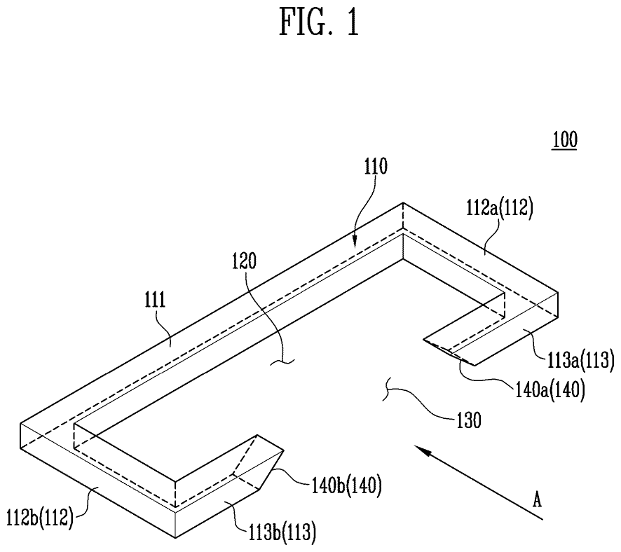

FIG. 1 is a diagram illustrating a coating shim for electrode slurry discharge 100 according to an embodiment of the present disclosure.

The coating shim for electrode slurry discharge 100 according to an embodiment of the present disclosure includes a hollow region 120 through which the electrode slurry may flow; and a frame 110 which surrounds at least a part of the hollow region 120. The frame 110 includes a base portion 111 extending in one direction to form one side surface of the hollow region 120, side portions 112a and 112b (hereinafter collectively referred to as side portions 112) extending at opposite ends of the base portion 111 in a direction different from the one direction, and guide portions 113a and 113b (hereinafter collectively referred to as guide portions 113) extending at respective ends of the side portions 112 to face each other and to be spaced apart from each other to form a discharge port 130 therebetween which allows the hollow region 120 to communicate with the outside. The guide portions 113 may have inclined surfaces 140 at respective ends thereof such that a distance between lower portions of the guide portions 113 is greater than a distance between upper portions.

Referring to FIG. 1, the coating shim for electrode slurry discharge 100 may include the frame 110. The frame 110 may surround at least a part of the hollow region 120. The hollow region 120 may be a region through which the electrode slurry may flow.

Referring to FIG. 1, the frame 110 may include the base portion 111 extending in one direction to form one side surface of the hollow region 120, the side portions 112 extending at opposite ends of the base portion 111 in a direction different from the one direction, and the guide portions 113 extending at respective ends of the side portions 112 to face each other and to be spaced apart from each other to form the discharge port 130 therebetween which allows the hollow region 120 to communicate with the outside.

The side portions 112 may be a pair extending in the direction different from the direction in which the base portion 111 extends at opposite ends of the base portion 111, respectively.

Referring to FIG. 1, the side portions 112 may be configured as a pair having the same extension direction. However, the side portions 112 according to the present disclosure are not necessarily limited thereto, and may be configured as a pair having different extension directions as necessary.

Referring to FIG. 1, the side portions 112 may be configured as a pair having the same length. However, the side portions 112 according to the present disclosure are not necessarily limited thereto, and may be configured as a pair having different lengths as necessary.

Referring to FIG. 1, the side portions 112 may each extend in a direction perpendicular to the extension direction of the base portion 111. However, the side portions 112 according to the present disclosure are not necessarily limited thereto, and may extend to surround at least a part of the hollow region 120 at various angles with the extension direction of the base portion 111 as necessary.

The guide portions 113 may extend to face each other at respective ends of the side portions 112. Extending the guide portions 113 to face each other may mean that the guide portions 113 extend such that an end-to-end distance of the guide portions 113 is smaller than that of the side portions 112.

The guide portions 113 may be formed in a pair to extend to face each other at respective ends of the side portions 112 formed in a pair as described above, and to be spaced apart from each other to form the discharge port 130 therebetween (that is, a spaced region) which allows the hollow region 120 to communicate with the outside.

Referring to FIG. 1, the guide portions 113 may be configured as a pair having extension directions which are opposite to each other. However, the guide portions 113 according to the present disclosure are not necessarily limited thereto, and if necessary, may be configured as a pair having different extension directions but facing each other.

Referring to FIG. 1, the guide portions 113 may be configured as a pair having the same length. However, the guide portions 113 according to the present disclosure are not necessarily limited thereto, and may be configured as a pair having different lengths as necessary.

Referring to FIG. 1, the guide portions 113 may each extend in a direction perpendicular to the extension direction of the side portions 112. However, the guide portions 113 according to the present disclosure are not necessarily limited thereto, and may extend to surround at least a part of the hollow region 120 while facing each other at various angles with the extension direction of the side portions 112 as necessary.

In an embodiment, the guide portions 113 may be formed such that the discharge port 130 opened to discharge the electrode slurry to the outside is formed by causing the hollow region 120 to communicate with the outside. That is, the remaining portion of the hollow region 120 except a portion where the discharge port 130 is located may be closed. Accordingly, the discharge port 130 may be defined as a space (a spaced region) between the guide portions 113.

In an embodiment, at respective ends of the guide portions 113, inclined surfaces 140a and 140b (hereinafter collectively referred to as the inclined surfaces 140) may be formed such that the distance between the lower portions of the guide portions 113 is greater than the distance between the upper portions.

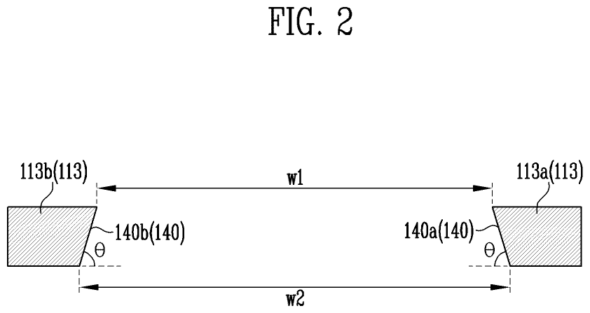

Referring to FIG. 1, when each of the guide portions 113 has an upper surface and a lower surface which are parallel to each other, a minimum value of a distance between the lower surfaces of the guide portions 113 may be defined as the distance between the lower portions, and a minimum value of a distance between the upper surfaces of the guide portions 113 may be defined as the distance between the upper portions. The above definitions will be explained in more detail in the descriptions with reference to FIGS. 2 to 5 to be described below.

Referring to FIG. 1, the inclined surfaces 140 may be in a shape symmetrical to each other. However, the inclined surfaces 140 according to the present disclosure are not necessarily limited thereto, and if necessary, the inclined surfaces formed at respective ends of the guide portions 113 may be asymmetrical to each other.

Referring to FIG. 1, the inclined surfaces 140 may be formed at respective ends of the guide portions 113 and may be adjacent to the discharge port 130, and each of the inclined surfaces 140 may be defined as one surface on the frame 110 in which the electrode slurry discharged from the hollow region 120 to the outside comes into direct contact during a discharge process.

In an embodiment, as described above, the inclined surfaces 140 may be formed such that the distance between the lower portions of the guide portions 113 is greater than the distance between the upper portions. Accordingly, a width of the discharge port 130 may increase from an upper portion toward a lower portion thereof.

In an embodiment, the side portions 112 extend in the same direction at opposite ends of the base portion 111, and an upper end and a lower end of the inclined surface 140 may be parallel to the extension direction of the side portions 112.

Referring to FIG. 1, the guide portions 113 may each extend in the direction perpendicular to the extension direction of the side portions 112. The upper end and the lower end of the inclined surface 140 may be parallel to the extension direction of the side portions 112 and may be perpendicular to the extension direction of the base portion 111.

According to an embodiment, the upper end of the inclined surface 140 may mean an upper end portion of a boundary at which the inclined surface 140 is in contact with the guide portion 113. The lower end of the inclined surface 140 may mean a lower end portion of a boundary at which the inclined surface 140 is in contact with the guide portion 113.

Referring to FIG. 1, when the guide portion 113 has the upper surface and the lower surface which are parallel to each other as described above, the upper end of the inclined surface 140 may be defined as a boundary at which the inclined surface 140 is in contact with the upper surface of the guide portion 113, and the lower end of the inclined surface 140 may be defined as a boundary at which the inclined surface 140 is in contact with the lower surface of the guide portion 113.

In an embodiment, the inclined surfaces 140 may be formed such that the difference between the distance between the lower portions of the guide portions 113 and the distance between the upper portions of the guide portions 113 is greater than or equal to 0.5 mm and less than or equal to 5.0 mm. In a specific embodiment, the inclined surfaces 140 may be formed such that the difference between the distance between the lower portions of the guide portions 113 and the distance between the upper portions of the guide portions 113 is greater than or equal to 0.5 mm and less than or equal to 3.0 mm, and in a more specific embodiment, the inclined surfaces 140 may be formed such that the difference between the distance between the lower portions of the guide portions 113 and the distance between the upper portions of the guide portions 113 is greater than or equal to 1.0 mm and less than or equal to 2.0 mm.

When the difference between the distance between the lower portions of the guide portions 113 and the distance between the upper portions of the guide portions 113 exceeds the above numerical range, the electrode slurry is not evenly applied to an electrode current collector, so that a loading deviation between the center and opposite ends of an electrode may increase, and when the difference is less than the above numerical range, the coating quality improvement effect in the present disclosure may be insignificant.

Therefore, within the above-described range, an electrode with a sufficiently high loading amount may be manufactured, and occurrence of electrode defects such as a side ring phenomenon and electrode extraction may be prevented or mitigated.

FIG. 2 is a cross-sectional view of the coating shim for electrode slurry discharge according to an embodiment of the present disclosure viewed from direction A of FIG. 1.

In an embodiment, the inclined surface 140 may be a flat surface.

Referring to FIG. 2, the distance between the upper portions of the guide portions 113 described above may be defined as w1, and the distance between the lower portions of the guide portions 113 may be defined as w2. In an embodiment, a value of w2−w1 may be greater than or equal to 0.5 mm and less than or equal to 5.0 mm, specifically greater than or equal to 0.5 mm and less than or equal to 3.0 mm, and more specifically greater than or equal to 1.0 mm and less than or equal to 2.0 mm.

Referring to FIG. 2, the inclined surface 140 is configured as a flat surface. That is, a slope of the inclined surface 140 may be constant from the upper end to the lower end.

In an embodiment, the slope of the inclined surface 140 may be greater than or equal to 0.10 and less than or equal to 6.00. In a specific embodiment, the slope of the inclined surface 140 may be greater than or equal to 0.33 and less than or equal to 4.00, and in a more specific embodiment, the slope of the inclined surface 140 may be greater than or equal to 0.50 and less than or equal to 3.00. The slope may mean the magnitude of the absolute value of the slope. Specifically, when an angle formed between the inclined surface 140 and one surface on which the coating shim 100 may be placed is θ (0<θ<90), the angle may be equal to a value of tan θ.

When the above slope exceeds the above numerical range, the electrode slurry is not evenly applied to the electrode current collector, so that a loading deviation between the center and opposite ends of the electrode may increase, and when the slope is less than the above numerical range, the coating quality improvement effect in the present disclosure may be insignificant.

Therefore, within the above-described range, an electrode with a sufficiently high loading amount may be manufactured, and occurrence of electrode defects such as a side ring phenomenon and electrode extraction may be prevented or mitigated.

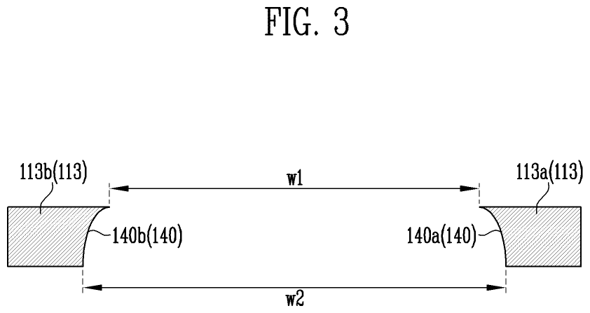

FIG. 3 is a cross-sectional view of the coating shim for electrode slurry discharge according to another embodiment of the present disclosure viewed from the same direction as in FIG. 2. In an embodiment, the inclined surface 140 may be a curved surface.

Referring to FIG. 3, the distance between the upper portions of the guide portions 113 described above may be defined as w1, and the distance between the lower portions of the guide portions 113 may be defined as w2. In an embodiment, a value of w2−w1 may be greater than or equal to 0.5 mm and less than or equal to 5.0 mm, specifically greater than or equal to 0.5 mm and less than or equal to 3.0 mm, and more specifically greater than or equal to 1.0 mm and less than or equal to 2.0 mm.

Referring to FIG. 3, the inclined surface 140 is configured as a curved surface. That is, a slope of the inclined surface 140 might not be constant from the upper end to the lower end.

In an embodiment, the slope of the inclined surface 140 may increase from the upper end toward the lower end thereof. That is, the inclined surface 140 may be in a convex shape upward. The slope may mean a slope of a tangent line at a point on the inclined surface 140. The slope of the tangent line may be defined by the above-described method.

In an embodiment, a radius of curvature of the inclined surface 140 may be greater than or equal to 0.5 mm and less than or equal to 3.0 mm. In a specific embodiment, the radius of curvature of the inclined surface 140 may be greater than or equal to 1.0 mm and less than or equal to 2.0 mm, and in a more specific embodiment, the radius of curvature of the inclined surface 140 may be greater than or equal to 1.0 mm and less than or equal to 1.5 mm.

When the above radius of curvature exceeds the above numerical range, it may be difficult to adjust the coating width at the lower end, and may cause poor adhesion and poor quality of the coating side. When the radius of curvature is less than the above numerical range, the coating quality improvement effect in the present disclosure may be insignificant.

Therefore, within the above-described range, an electrode with a sufficiently high loading amount may be manufactured, and occurrence of electrode defects such as a side ring phenomenon and electrode extraction may be prevented or mitigated.

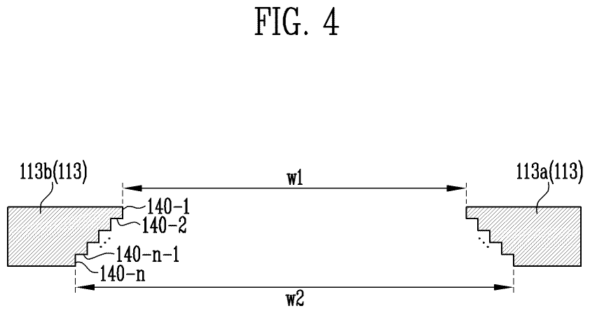

FIG. 4 is a cross-sectional view of the coating shim for electrode slurry discharge according to another embodiment of the present disclosure viewed from the same direction as in FIG. 2.

In an embodiment, the inclined surface 140 includes first to n-th sub-surfaces 140-1 to 140-n (n is a natural number greater than or equal to 2), and in terms of the first to n-th sub-surfaces, the n-th sub-surface 140-n is located to be in contact with a lower end of the (n−1)-th sub-surface 140-n−1 with different slopes from each other, and each of the first to n-th sub-surfaces may be a flat surface.

According to an embodiment, a lower end of the first sub-surface 140-1 may mean a boundary at which the first sub-surface 140-1 is in contact with the second sub-surface 140-2. In this sense, the lower end of the (n−1)-th sub-surface 140-n−1 may mean a boundary at which the (n−1)-th sub-surface 140-n−1 is in contact with the n-th sub-surface 140-n.

Referring to FIG. 4, the first to n-th sub-surfaces, which alternate between a slope of ∞ (infinity) and a slope of 0 (or an angle, which is formed between a sub-surface and one surface on which the coating shim 100 may be placed, may alternate between 90° and) 180° and each of which is positioned to be successively in contact with a lower end of a preceding sub-surface, may define the inclined surface 140 as a set. In other words, the inclined surface 140 may be in a stepped structure, and specifically may be in a cascade structure. However, the present disclosure is not necessarily limited thereto, and each sub-surface may have various slopes as necessary. The slope may be defined by the above-described method.

Referring to FIG. 4, the distance between the upper portions of the guide portions 113 described above may be defined as w1, and the distance between the lower portions of the guide portions 113 may be defined as w2. In an embodiment, a value of w2−w1 may be greater than or equal to 0.5 mm and less than or equal to 5.0 mm, specifically greater than or equal to 0.5 mm and less than or equal to 3.0 mm, and more specifically greater than or equal to 1.0 mm and less than or equal to 2.0 mm.

In an embodiment, n may be a natural number greater than or equal to 7. When n is a natural number greater than or equal to 7, electrode defects may be more effectively prevented or mitigated.

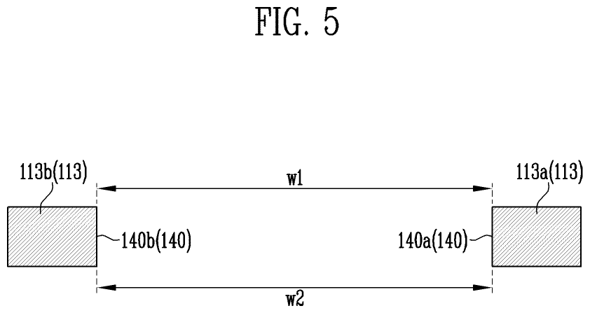

FIG. 5 is a cross-sectional view of a coating shim for electrode slurry discharge according to a comparative example viewed from the same direction as in FIG. 2.

Referring to FIG. 5, unlike the above-described embodiments of the present disclosure, the distance w1 between the upper portions of the guide portions 113 and the distance w2 between the lower portions of the guide portions 113 may be the same.

Accordingly, the inclined surface 140 may be formed such that the distance between the lower portions of the guide portions 113 and the distance between the upper portions of the guide portions 113 are the same.

When the electrode slurry is discharged by a configuration including the guide portions 113 having the cross-sectional structure in the shape shown in FIG. 5, it may be difficult to manufacture an electrode with a high loading amount, and electrode defects such as a side ring phenomenon and electrode extraction may occur.

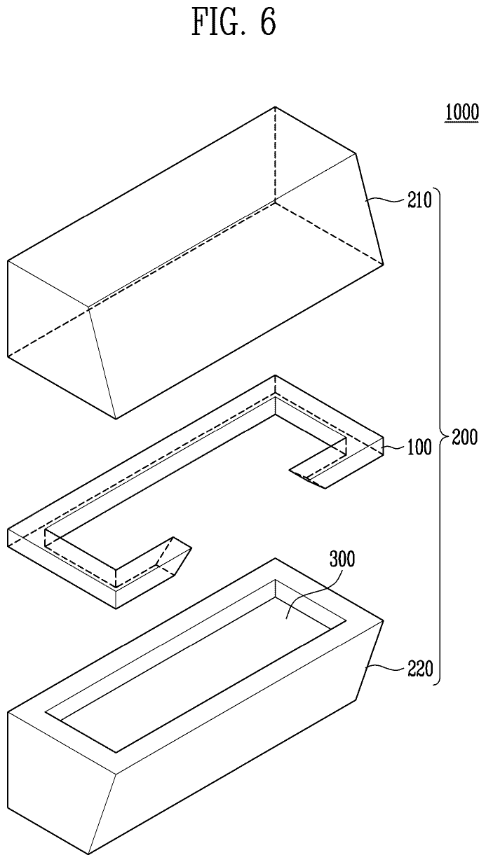

FIG. 6 is a diagram illustrating an electrode slurry coating die 1000 according to an embodiment of the present disclosure.

The coating die 1000 for electrode slurry discharge according to an embodiment of the present disclosure includes a die portion 200 including an upper die 210 and a lower die 220 coupled to the upper die 210 to form an inner space 300 in which the electrode slurry is accommodated; a hollow region interposed between the upper die 210 and the lower die 220 and communicating with the inner space 300; and a frame surrounding at least a part of the hollow region. The frame includes a base portion extending in one direction to form one side surface of the hollow region; side portions extending at opposite ends of the base portion in a direction different from the one direction; and guide portions extending at respective ends of the side portions to face each other and to be spaced apart from each other to form a discharge port therebetween which allows the hollow region to communicate with the outside. The guide portions may have inclined surfaces at respective ends thereof such that a distance between lower portions of the guide portions is greater than a distance between upper portions.

Referring to FIG. 6, the electrode slurry coating die 1000 includes the coating shim 100 and the die portion 200.

The die portion 200 includes the upper die 210 and the lower die 220. The lower die 220 may be coupled to the upper die 210 to form, with the upper die 210, the inner space 300 in which the electrode slurry is accommodated.

The coating shim 100 including the hollow region and the frame may be interposed between the upper die 210 and the lower die 220.

The coating shim 100 may include the hollow region in communication with the inner space 300. The hollow region may be a region through which the electrode slurry may flow.

In addition, the coating shim 100 may include the frame surrounding at least a part of the hollow region. The frame may include the base portion extending in one direction to form one side surface of the hollow region, the side portions extending at opposite ends of the base portion in a direction different from the one direction, and the guide portions extending at respective ends of the side portions to face each other and to be spaced apart from each other to form the discharge port therebetween which allows the hollow region to communicate with the outside.

In an embodiment, the frame may have the inclined surfaces formed at respective ends of the guide portions such that the distance between the lower portions of the guide portions is greater than the distance between the upper portions.

In an embodiment, the side portions extend in the same direction at respective ends of the base portion, and an upper end and a lower end of each of the inclined surfaces may be parallel to the extension direction of the side portions.

In an embodiment, the inclined surface may be formed such that the difference between the distance between the lower portions of the guide portions and the distance between the upper portions of the guide portions is greater than or equal to 0.5 mm or less than or equal to 5.0 mm.

In an embodiment, the inclined surface may be a flat surface or a curved surface. That is, the inclined surface may be a flat surface with a constant slope or a curved surface with a changing slope.

In another embodiment, the inclined surface includes first to n-th sub-surfaces (n is a natural number greater than or equal to 2), the n-th sub-surface is located to be in contact with a lower end of the (n−1)-th sub-surface with different slopes from each other, and the first to n-th sub-surfaces may each be a flat surface.

All the features of the coating shim described with reference to FIGS. 1 to 4 may be applied to the coating shim 100 of FIG. 6.

The electrode slurry coating die 1000 may further include a supply portion (not shown) for supplying an electrode slurry to the inner space 300. The electrode slurry supplied from the supply portion (not shown) may be supplied to the inner space 300, moved to the hollow region, and then discharged through the discharge port.

The die portion 200 in FIG. 6 includes two dies 210 and 220 but is not limited to, and the die portion 200 may include two or more dies.

For example, the die portion 200 may include a first die, a second die, a third die, and a fourth die, and two coating shims 100 may be interposed between the first die and the second die, and between the third die and the fourth die, respectively.

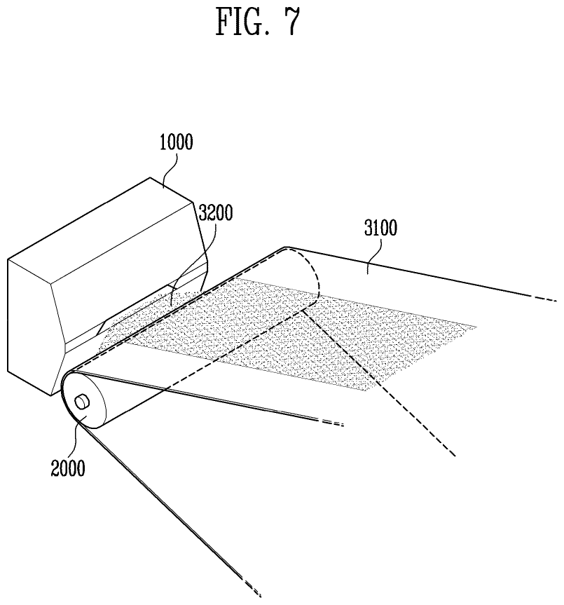

FIG. 7 is a diagram illustrating an electrode manufacturing device 10000 according to an embodiment of the present disclosure.

The electrode manufacturing device according to an embodiment of the present disclosure includes a transfer portion 2000 supporting and transferring an electrode current collector 3100; and the electrode slurry coating die 1000 discharging an electrode slurry 3200 to the electrode current collector 3100. The electrode slurry coating die 1000 includes a die portion including an upper die and a lower die coupled to the upper die to form an inner space in which the electrode slurry 3200 is accommodated; a hollow region interposed between the upper die and the lower die and communicating with the inner space, and a frame surrounding at least a part of the hollow region. The frame includes a base portion extending in one direction to form one side surface of the hollow region; side portions extending at opposite ends of the base portion in a direction different from the one direction; and guide portions extending at respective ends of the side portions to face each other and to be spaced apart from each other to form a discharge port allowing the hollow region to communicate with the outside. The guide portions may have inclined surfaces at respective ends thereof such that a distance between lower portions of the guide portions is greater than a distance between upper portions.

Referring to FIG. 7, the electrode manufacturing device 10000 includes the electrode slurry coating die 1000 and the transfer portion 2000.

The transfer portion 2000 may support and transfer the electrode current collector 3100.

The configuration of the transfer portion 2000 is not particularly limited as long as a current collector in the form of a wound sheet may be continuously transferred. For example, the transfer portion 2000 may be a transfer roller as shown in FIG. 7. The transfer portion 2000 may receive and transfer the unwound electrode current collector 3100. Specifically, in a state where the unwound electrode current collector 3100 is located on the transfer roller, the electrode current collector 3100 may move toward the coating die 1000 by rotating the transfer roller.

The electrode slurry coating die 1000 may discharge the electrode slurry 3200 to the electrode current collector 3100. Accordingly, the electrode slurry 3200 may be coated on the electrode current collector 3100.

The electrode slurry coating die 1000 may be the electrode slurry coating die described in FIG. 6.

That is, the electrode slurry coating die 1000 may include a coating shim and the die portion.

The die portion may include the upper die and the lower die. The lower die may be coupled to the upper die to form, with the upper die, the inner space in which the electrode slurry 3200 is accommodated.

The coating shim including the hollow region and the frame may be interposed between the upper die and the lower die.

The coating shim may include the hollow region in communication with the inner space.

In addition, the coating shim may include the frame surrounding at least a part of the hollow region. The frame may include the base portion extending in one direction to form one side surface of the hollow region, the side portions extending at opposite ends of the base portion in a direction different from the one direction, and the guide portions extending at respective ends of the side portions to face each other and to be spaced apart from each other to form the discharge port therebetween which allows the hollow region to communicate with the outside.

In an embodiment, the frame may have the inclined surfaces formed at respective ends of the guide portions such that the distance between the lower portions of the guide portions is greater than the distance between the upper portions.

In an embodiment, a direction from the lower portion toward the upper portion of each of the guide portions may be the same as a direction in which the transfer portion 2000 transfers the electrode current collector 3100.

In addition, in an embodiment, the electrode slurry 3200 may be discharged in accordance with the shape of the discharge port.

All the features of the coating shim and the coating die 1000 described with reference to FIGS. 1 to 4 and 6 may be applied to the electrode manufacturing device 10000 of FIG. 7.

In an embodiment, the electrode manufacturing device 10000 may further include a drying portion (not shown) for drying the electrode slurry 3200 applied on the electrode current collector 3100. The drying portion (not shown) is not limited as long as the drying portion is a device in a form capable of evaporating a solvent from the electrode slurry 3200, and may have any conventionally known structure, and may be performed, for example, by heating and/or hot-air drying. As a more specific example, the drying portion may include a hot air nozzle and an infrared (IR) lamp for generating hot air in a drying oven.

In addition, the electrode manufacturing device 10000 may further include a winder (not shown) for winding an electrode formed by drying the electrode slurry 3200 applied on the electrode current collector 3100. In an embodiment, the winder (not shown) may be in a form of a roller, and the electrode may be wound as the roller rotates.

In an embodiment, the electrode current collector 3100 may be a positive electrode current collector or a negative electrode current collector.

The electrode current collector 3100 is not particularly limited as long as the electrode current collector 3100 has conductivity without causing a chemical change in a secondary battery.

The electrode slurry 3200 may include an electrode active material and a solvent. The electrode slurry 3200 may be a positive electrode slurry or a negative electrode slurry.

A positive electrode active material is a material which lithium ions can be inserted into and extracted from, and may be, for example, a lithium metal oxide. A negative electrode active material may be a material which lithium ions can be absorbed into and extracted from, and may be, for example, a silicon-based material or a carbon-based material.

The solvent is a material in which the positive electrode active material or the negative electrode active material can be dissolved, and for example, the solvent may include one or more materials selected from the group consisting of water, methanol, ethanol, ethylene glycol, diethylene glycol, and glycerol.

In addition, the positive electrode slurry or the negative electrode slurry may further include a binder and a conductive material. The binder may enhance mechanical stability by mediating the bonding between the electrode current collector 3100 and the electrode active material, and the conductive material may enhance the electrical conductivity of a lithium secondary battery.

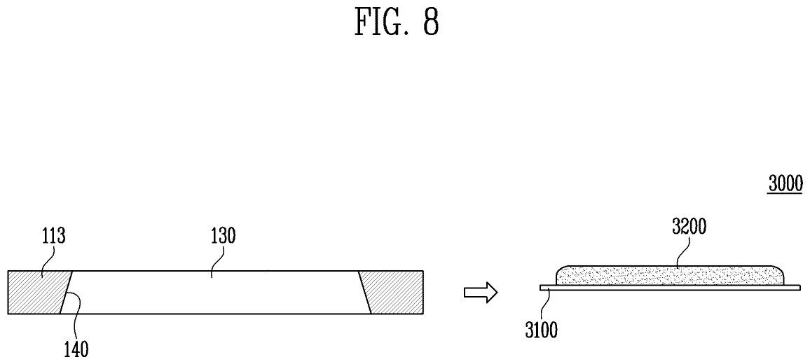

FIG. 8 is a diagram illustrating an electrode 3000 manufactured by an electrode manufacturing device according to an embodiment of the present disclosure.

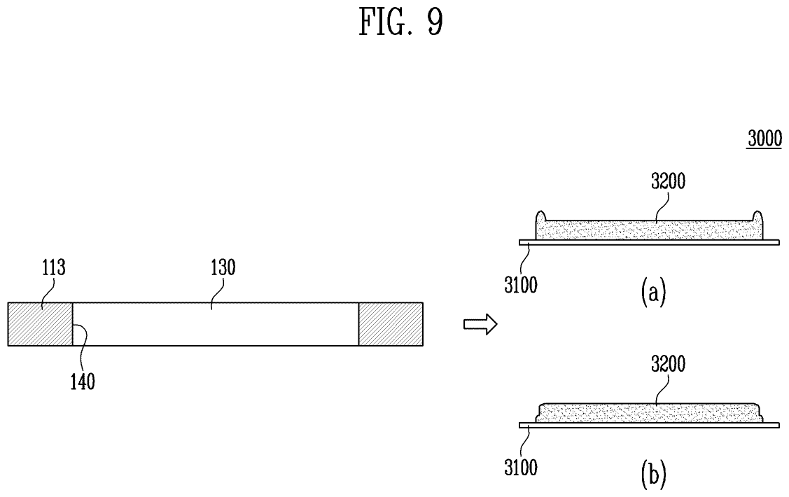

FIG. 9 is a diagram illustrating an electrode manufactured by an electrode manufacturing device according to a comparative example.

Referring to FIG. 8, the electrode slurry 3200 may be applied on the electrode current collector 3100 in accordance with a cross-sectional shape of the discharge port 130 formed according to the shapes of the inclined surfaces 140 of the coating shim and the shapes of the upper die and the lower die in the electrode slurry coating die. The electrode slurry 3200 discharged from the discharge port 130 having a cross-sectional shape as shown on the left of FIG. 8 and applied onto the electrode current collector 3100 may form the electrode 3000 in a form as shown on the right of FIG. 8.

Referring to FIG. 9, the electrode slurry 3200 may be applied on the electrode current collector 3100 in accordance with a cross-sectional shape of the discharge port 130 formed according to the shapes of the inclined surfaces 140 of the coating shim and the shapes of the upper die and the lower die in the electrode slurry coating die. The electrode slurry 3200 discharged from the discharge port 130 having a cross-sectional shape as shown on the left of FIG. 9 and applied onto the electrode current collector 3100 may form the electrode 3000 in a form as shown in (a) on the right of FIG. 9, or may form the electrode 3000 in a form as shown in (b) on the right of FIG. 9.

First, as shown in FIG. 8, when the electrode 3000 is manufactured by the electrode manufacturing device according to an embodiment of the present disclosure, that is, when the electrode slurry 3200 is discharged from the electrode slurry coating die having the discharge port 130 defined by forming the inclined surfaces 140 such that the distance between the lower portions of the guide portions is greater than the distance between the upper portions, a loading amount of the electrode slurry 32000 applied on the electrode current collector 3100 is relatively uniform in the width direction, and a side ring phenomenon might not occur.

On the other hand, as shown in FIG. 9, when the electrode 3000 is manufactured by the electrode manufacturing device according to the comparative example, that is, when the electrode slurry 3200 is discharged from the electrode slurry coating die having the discharge port 130 defined by forming the inclined surfaces 140 such that the distance between the lower portions of the guide portions is equal to the distance between the upper portions, a loading amount of the electrode slurry 3200 applied on the electrode current collector 3100 may be relatively great or insufficient at the edge compared to a loading amount of the center in the width direction.

When the loading amount at the edge of the electrode slurry 3200 is relatively great or insufficient, drying unevenness may occur at the center and the edge in the width direction of the electrode slurry 3200, and thus a side ring phenomenon may occur, cracking or falling off of the electrode 3000 may occur, or process problems such as surface contamination of a rolling roll may occur.

When the electrode is manufactured using the electrode manufacturing device according to an embodiment of the present disclosure, the coating quality may be enhanced, and thus the processability may be improved.

What is claimed is:

1. A coating shim for electrode slurry discharge, comprising:
a hollow region through which an electrode slurry may flow; and
a frame surrounding at least a part of the hollow region,
wherein the frame comprises:
a base portion extending in one direction to form one side surface of the hollow region;
side portions extending at opposite ends of the base portion in a direction different from the one direction; and
guide portions extending at respective ends of the side portions to face each other and to be spaced apart from each other to form a discharge port therebetween which allows the hollow region to communicate with outside, and
wherein the guide portions have inclined surfaces at respective ends thereof such that a distance between lower portions of the guide portions is greater than a distance between upper portions of the guide portions.

2. The coating shim for electrode slurry discharge of claim 1, wherein the side portions extend in a same direction at the opposite ends of the base portion, and
wherein an upper end and a lower end of each of the inclined surfaces are parallel to the direction in which the side portions extend.

3. The coating shim for electrode slurry discharge of claim 1, wherein the inclined surfaces are formed such that a difference between the distance between the lower portions of the guide portions and the distance between the upper portions of the guide portions is greater than or equal to 0.5 mm and less than or equal to 5.0 mm.

4. The coating shim for electrode slurry discharge of claim 1, wherein each of the inclined surfaces is a flat surface.

5. The coating shim for electrode slurry discharge of claim 4, wherein a slope of each of the inclined surfaces is greater than or equal to 0.10 and less than or equal to 6.00.

6. The coating shim for electrode slurry discharge of claim 1, wherein each of the inclined surfaces is a curved surface.

7. The coating shim for electrode slurry discharge of claim 6, wherein a slope of each of the inclined surfaces increases from an upper end toward a lower end thereof.

8. The coating shim for electrode slurry discharge of claim 6, wherein a radius of curvature of each of the inclined surfaces is greater than or equal to 0.5 mm and less than or equal to 3.0 mm.

9. The coating shim for electrode slurry discharge of claim 1, wherein each of the inclined surfaces includes first to n-th sub-surfaces (n is a natural number of 2 or more),
wherein in terms of the first to n-th sub-surfaces, the n-th sub-surface is positioned to be in contact with a lower end of the (n−1)-th sub-surface with different slopes from each other, and
wherein each of the first to n-th sub-surfaces is a flat surface.

10. An electrode slurry coating die, comprising:
a die portion including an upper die and a lower die coupled to the upper die to form an inner space in which an electrode slurry is accommodated;
a hollow region interposed between the upper die and the lower die and communicating with the inner space; and
a frame surrounding at least a part of the hollow region,
wherein the frame comprises:
a base portion extending in one direction to form one side surface of the hollow region;
side portions extending at opposite ends of the base portion in a direction different from the one direction; and
guide portions extending at respective ends of the side portions to face each other and to be spaced apart from each other to form a discharge port therebetween which allows the hollow region to communicate with outside, and
wherein the guide portions have inclined surfaces at respective ends thereof such that a distance between lower portions of the guide portions is greater than a distance between upper portions of the guide portions.

11. The electrode slurry coating die of claim 10, wherein the side portions extend in a same direction at the opposite ends of the base portion, and
wherein an upper end and a lower end of each of the inclined surfaces are parallel to the direction in which the side portions extend.

12. The electrode slurry coating die of claim 10, wherein the inclined surfaces are formed such that a difference between the distance between the lower portions of the guide portions and the distance between the upper portions of the guide portions is greater than or equal to 0.5 mm and less than or equal to 5.0 mm.

13. The electrode slurry coating die of claim 10, wherein each of the inclined surfaces is a flat surface or a curved surface.

14. An electrode manufacturing device, comprising:
a transfer portion supporting and transferring an electrode current collector; and
an electrode slurry coating die discharging an electrode slurry to the electrode current collector,
wherein the electrode slurry coating die comprises:
a die portion including an upper die and a lower die coupled to the upper die to form an inner space in which the electrode slurry is accommodated;
a hollow region interposed between the upper die and the lower die and communicating with the inner space; and
a frame surrounding at least a part of the hollow region,
wherein the frame comprises:
a base portion extending in one direction to form one side surface of the hollow region;
side portions extending at opposite ends of the base portion in a direction different from the one direction; and
guide portions extending at respective ends of the side portions to face each other and to be spaced apart from each other to form a discharge port therebetween which allows the hollow region to communicate with outside, and
wherein the guide portions have inclined surfaces at respective ends thereof such that a distance between lower portions of the guide portions is greater than a distance between upper portions of the guide portions.

15. The electrode manufacturing device of claim 14, wherein a direction from a lower portion toward an upper portion of each of the guide portions is the same as a direction in which the transfer portion transfers the electrode current collector.
